(19) United States
(12) Patent Application Publication
(10) Pub. No.: US 2021/0001914 A1
(43) Pub. Date: Jan. 7, 2021

(54) VEHICLE INPUT DEVICE

(71) Applicant: DENSO CORPORATION, Kariya-city (JP)

(72) Inventors: Takafumi OKAYASU, Kariya-city (JP); Daisuke NAMEKAWA, Kariya-city (JP)

(21) Appl. No.: 17/026,806

(22) Filed: Sep. 21, 2020

Related U.S. Application Data
(63) Continuation of application No. PCT/JP2019/007585, filed on Feb. 27, 2019.

(30) Foreign Application Priority Data
Mar. 23, 2018 (JP) 2018-056251

(51) Int. Cl. B62D 1/04; B60K 35/00; B60K 37/06; G06N 20/00

(52) U.S. Cl. CPC B62D 1/046; B60K 35/00; B60K 2370/782; G06N 20/00; B60K 2370/143; B60K 37/06

(57) ABSTRACT

A vehicle input device includes a touch sensor provided in a grip portion of a steering wheel, a holding position determiner configured to determine whether a user is holding the grip portion and determine a holding position at which the user is holding the grip portion based on an input signal from the touch sensor, an operation area setting unit configured to set an operation area of the touch sensor at a position adjacent to a thumb and an index finger of a user's hand based on the holding position, and an operation detector configured to detect an operation by a finger of the user to the operation area of the touch sensor.

### CROSS REFERENCE TO RELATED APPLICATION

The present application is a continuation application of International Patent Application No. PCT/JP2019/007585 filed on Feb. 27, 2019, which designated the U.S. and claims the benefit of priority from Japanese Patent Application No. 2018-056251 filed on Mar. 23, 2018. The entire disclosures of all of the above applications are incorporated herein by reference.

### TECHNICAL FIELD

The present disclosure relates to a vehicle input device installed in a vehicle.

### BACKGROUND

As a vehicle input device by which a driver operates in-vehicle devices, some devices include a touch sensor provided in a rim portion of a steering wheel. In such devices, the touch sensor includes a grip detection area for detecting that the driver holds the steering wheel, and an operation detection area for detecting an operation (drag and tap) by a thumb or an index finger as separated areas. The touch sensor further includes an operation invalid area between the grip detection area and the operation detection area. Accordingly, the touch sensor is configured to distinguish whether the driver just holds the steering wheel or the driver input operations such as a drag and a tap. As a result, the driver can safely operate the in-vehicle devices while holding the steering wheel, and erroneous operations can be suppressed.

### SUMMARY

A vehicle input device according to an aspect of the present disclosure includes a touch sensor provided in a grip portion of a steering wheel, a holding position determiner configured to determine whether a user is holding the grip portion and determine a holding position at which the user is holding the grip portion based on an input signal from the touch sensor, an operation area setting unit configured to set an operation area of the touch sensor at a position adjacent to a thumb and an index finger of a user's hand based on the holding position, and an operation detector configured to detect an operation by a finger of the user to the operation area of the touch sensor. The holding position determiner is configured to determine a size of a user's hand and a position of the finger. The operation area setting unit is configured to set the operation area of the touch sensor based on the size of the user's hand such that the operation area is large when the user's hand is large. The operation area setting unit is configured to set the operation area of the touch sensor based on the position of the finger such that the operation area is adjacent to the finger and thereby the finger reaches the operation area.

A vehicle input device according to another aspect of the present disclosure includes a touch sensor provided in a grip portion of a steering wheel, and a processor coupled with the touch sensor. The processor is programmed to determine whether a user is holding the grip portion based on an input signal from the touch sensor, determine a holding position at which the user is holding the grip portion based on the input signal from the touch sensor. The processor is programmed to determine a size of a user's hand. The processor is programmed to determine a position of a thumb of the user's hand based on the holding position. The processor is programmed to set an operation area of the touch sensor at a position adjacent to the thumb based on the position of the thumb such that the thumb reaches the operation area, and based on the size of the user's hand such that the operation area is large when the user's hand is large. The processor is programmed to detect an operation by the thumb to the operation area of the touch sensor.

### BRIEF DESCRIPTION OF THE DRAWINGS

FIG. 1 is a block diagram illustrating a vehicle input device according to an embodiment.

FIG. 2 is a flowchart illustrating a processing procedure regarding an operation input executed by a control unit.

FIG. 3A is a diagram illustrating an example of a manner of holding a steering wheel different from the manner showing in FIG. 1.

FIG. 3B is a diagram illustrating an example of a manner of holding the steering wheel different from the manner showing in FIG. 1.

FIG. 3C is a diagram illustrating an example of a manner of holding the steering wheel different from the manner showing in FIG. 1.

FIG. 3D is a diagram illustrating an example of a manner of holding the steering wheel different from the manner showing in FIG. 1.

FIG. 4A is a diagram illustrating an example of an operation area in a case where a size of a user's hand is relatively large.

FIG. 4B is a diagram illustrating an example of the operation area in a case where the size of the user's hand is relatively small.

### EMBODIMENTS

### Comparative Example

A vehicle input device according to a comparative example of the present disclosure includes a touch sensor provided in a rim portion of a steering wheel. The touch sensor includes a grip detection area for detecting that the driver holds the steering wheel, and an operation detection area for detecting an operation (drag and tap) by a thumb or an index finger as separated areas. The touch sensor further includes an operation invalid area between the grip detection area and the operation detection area. Accordingly, the touch sensor is configured to distinguish whether the driver just holds the steering wheel or the driver input operations such as a drag and a tap. As a result, the driver can safely operate the in-vehicle devices while holding the steering wheel, and erroneous operations can be suppressed.

By the way, the size of the hand is different depending on the user. Accordingly, when the driver (user) holds the steering wheel, the region where the finger reaches is different depending on the user. Further, the position where the user holds the steering wheel is different depending on the user. Some users may hold an upper part of the steering wheel, some other users may hold a middle part, and the other users may hold a lower part. Moreover, the manner of holding the steering wheel may be different depending on the user. Some users may hold the steering wheel such that palms face upward, and some users may hold the steering wheel with one hand. The vehicle input device of the comparative example may not deal with the differences in the size of the user and the manner of holding the steering wheel. Accordingly, in the case where the driver is female whose hand is small for example, the driver needs to stretch out the finger to the operation detection area, and accordingly the input device may not be easy to use for the driver. That is, the input device of the comparative example may not be easy to use for some drivers.

### Embodiment

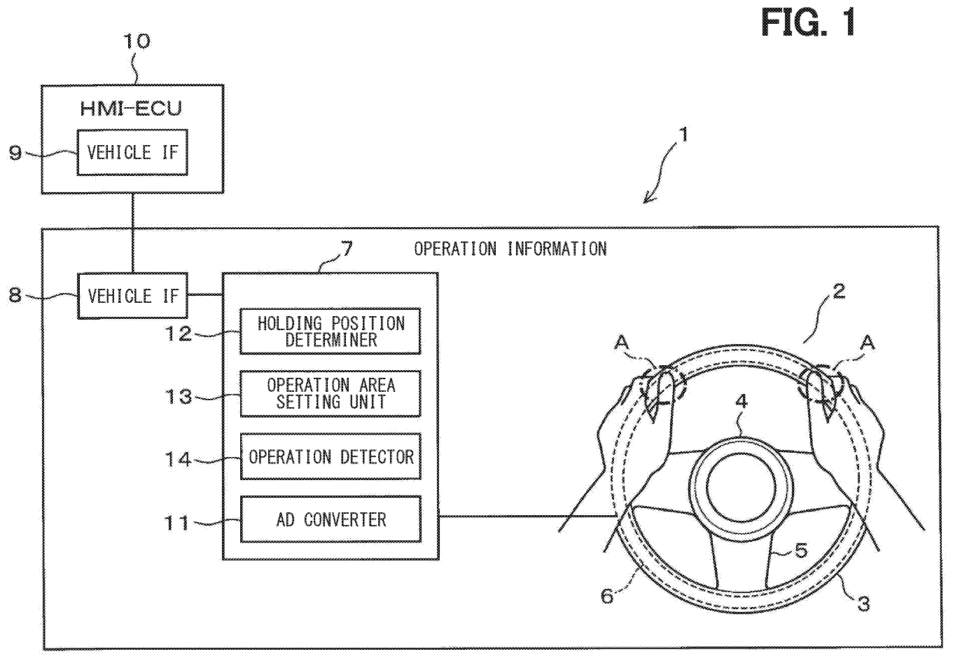

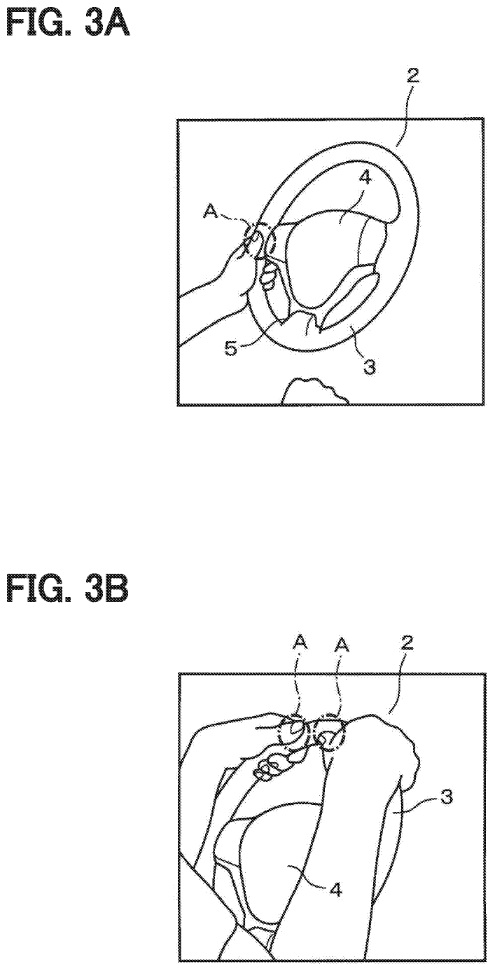

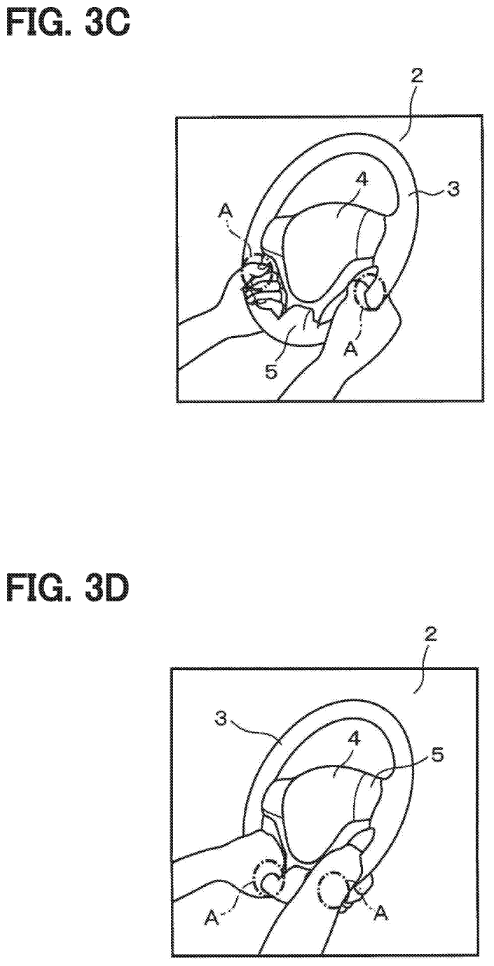

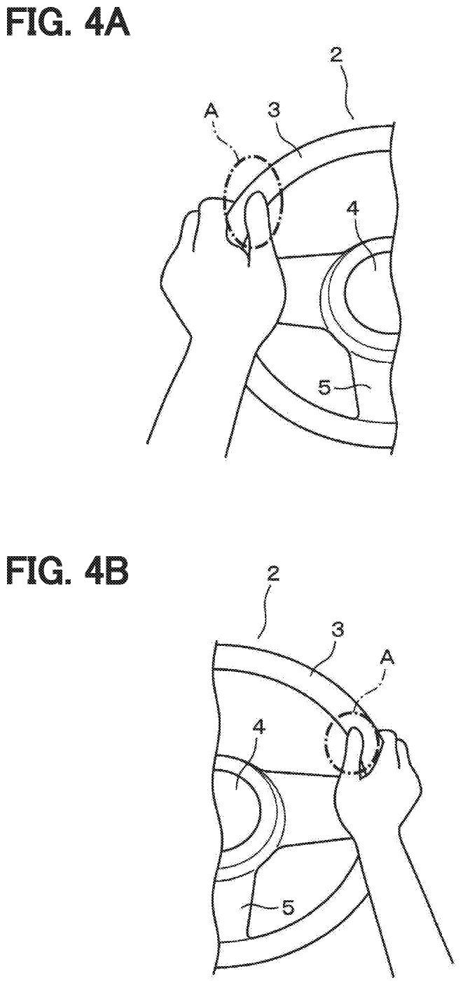

Hereinafter, one embodiment will be described with reference to the attached drawings. FIG. 1 schematically shows configurations of a vehicle input device 1 according to the present embodiment. As shown in FIGS. 3A-3D, 4A, and 4B, a steering wheel 2 is provided in front of a driver's seat of the vehicle. As generally known, the steering wheel 2 includes a grip portion (rim portion) 3 that a user grips to operate the steering wheel 2. The steering wheel 2 further includes a boss portion 4 positioned at a center of the steering wheel 2 and connected to a steering shaft, and a spork portion 5 connecting the grip portion 3 and the boss portion 4 at multiple parts, e.g. at a left part, a right part and a lower part of the boss portion 4.

As shown in FIG. 1, the vehicle input device 1 of the present embodiment includes a touch sensor 6 provided in the steering wheel 2, and a control unit 7 coupled with the touch sensor 6. The touch sensor 6 is a capacitive touch sensor, for example, and is provided in the entire surface of the grip portion 3 of the steering wheel 2. In this case, the touch sensor 6 is configured to divide the entire surface of the grip portion 3 into regions like a bitmap, and output the positions (regions) to which the hand or the finger of the user (driver) touches as a detection signal.

The control unit 7 is mainly composed of a computer including a CPU, a storage device, and the like, and is configured to process input signals from the touch sensor 6 to generate an operation information. The control unit 7 is connected with a network such as CAN and an in-vehicle LAN through a vehicle IF 8, and the operation information is transmitted from the network to an HMI control ECU 10 through a vehicle IF 9. The HMI control ECU 10 is configured to perform an input control of in-vehicle devices. For example, the HMI control ECU 10 is configured to control a start and an end of a hands-free call of a mobile phone (car phone). The HMI control ECU 10 may be configured to perform the input control of the in-vehicle devices such as a car navigation, an autonomous driving device, a cruise control device, a car audio, and a switch of a display device.

As shown in FIG. 1, the control unit 7 includes an AD converter 11 configured to convert an analog signal from the touch sensor 6 into a digital signal. Moreover, the control unit 7 has functions as a holding position determiner 12, an operation area setting unit 13, and an operation detector 14 configured as a software and a hardware as described below. The holding position determiner 12 is configured to, based on the input signal from the touch sensor 6, determine whether the user is holding the grip portion 3 of the steering wheel 2 and determine a holding position at which the user is holding the grip portion 3.

The operation area setting unit 13 is configured to, based on the holding position determined by the holding position determiner 12, automatically set an operation area A (see FIGS. 3A-3D, 4A, 4B) at a position adjacent to a thumb and an index finger of the user's hand. The operation area setting unit 13 may be configured to automatically set an operation area A in the vicinity of the thumb and the index finger of the user's hand. The operation detector 14 is configured to detect an operation by the finger of the user such as the thumb and the index finger to the operation area A of the touch sensor 6. The operation may include a gesture such as a tap and flick.

In the present embodiment, the holding position determiner 12 is configured to determine the size of the user's hand and the position of the finger based on the position at which the user is holding the grip portion 3 and the manner of holding the grip portion 3. Specifically, the holding position determiner 12 is configured to determine the size of the user's hand and the position of the finger holding the grip portion 3, especially the positions of the thumb and the index finger, using a pattern matching based on a machine learning. The operation area setting unit 13 is configured to set the operation area A of the touch sensor 6 based on the size of the user's hand holding the grip portion 3 and the positions of the fingers based on the position at which the user is holding the grip portion 3 and the manner of holding the grip portion 3.

With the above configurations, the control unit 7 sets the operation area A of the touch sensor 6 based on the input signal from the touch sensor 6. The operation detector 14 is configured to transmit the operation information representing the gesture to the HMI control ECU 10 upon the detection of the operation by the user to the operation area A. The HMI control ECU 10 is configured to output a control signal to the in-vehicle device accordingly.

For example, when the user taps the operation area A of the touch sensor 6, the operation information representing the tap is transmitted to the HMI control ECU 10, and then the HMI control ECU 10 gives an instruction to start (receive) a hands-free call. Afterward, when the user flicks the operation area A of the touch sensor 6, the operation information representing the flick is transmitted to the HMI control ECU 10, and then the HMI control ECU 10 gives an instruction to end the hands-free call.

Accordingly, the user can start (receive) the hands-free call by tapping the surface of the grip portion 3 with the thumb or the index finger while holding the grip portion 3 of the steering wheel 2. Afterward, the user can end the hands-free call by flick the surface of the grip portion 3 with the thumb or the index finger. It is needless to say that the present embodiment can be applied not only to the hands-free call but also to various operations of the in-vehicle devices described above.

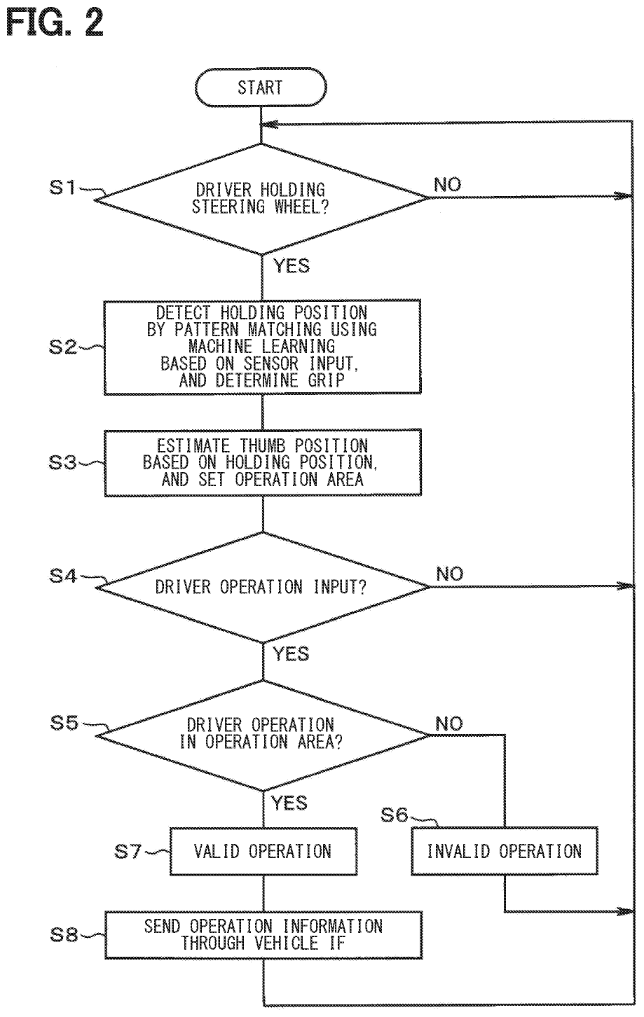

Next, effects of the vehicle input device 1 configured as described above are described with reference to FIGS. 2-4B. FIG. 2 is a flowchart showing a processing procedure regarding an operation input executed by the control unit 7. Firstly, in step S1, it is determined whether the user (driver) is holding the grip portion 3 of the steering wheel 2 based on the input signal from the touch sensor 6. When it is determined that the user is holding the grip portion 3 (step S1: Yes), the process proceeds to step S2.

In step S2, based on the input signal from the touch sensor 6, the size of the user's hand, the position at which the user is holding the grip portion 3, the manner of holding the grip portion 3, and accordingly the positions of the thumb and the index finger are determined using a pattern matching based on a machine learning. FIG. 1 shows a situation where the user is holding middle parts of the grip portion 3 of the steering wheel 2 in an up-down direction with the both hands, which is considered to be the most common way to hold the steering wheel 2. As exemplarily shown in FIGS. 3A-3D, some other patterns are conceivable as the holding position and the manner of holding the grip portion 3.

In an example shown in FIG. 3A, the user is holding the middle part of the left side of the grip portion 3 of the steering wheel 2 with the left hand, and releases the right hand from the steering wheel 2. In an example shown in FIG. 3B, the user is holding an upper part of the steering wheel 2 with the both hands. In an example shown in FIG. 3C, the user is holding a lower part of the steering wheel 2 with both hands such that the palms face upward. In an example shown in FIG. 3D, the user is holding the lower part of the steering wheel 2 with the both hands such that the palms face downward. In the present embodiment, the holding position and the manner of holding the steering wheel 2 which are different for each user are determined using the pattern matching based on the machine learning.

In step S3, the operation area A of the touch sensor 6 provided in the grip portion 3 is set based on the size of the user's hand, the holding position, the manner of holding the steering wheel 2, and especially the position of the thumb determined in step S2. In the present embodiment, as shown in FIGS. 1, 3A-3D, 4A-4B, the operation area A is set in a circle or an oval area around the position of the thumb where the thumb can reach. At this time, as shown in FIGS. 4A-4B as an example, the operation area varies in accordance with the size of the user's hand. For example, when the user's hand is relatively large, the operation area A is set to be relatively large as shown in FIG. 4A. For example, when the user's hand is relatively small, the operation area A is set to be relatively small as shown in FIG. 4B.

In step S4, it is determined whether the user inputs an operation to the touch sensor 6, that is, it is determined whether the input changes. When the user does not input an operation (step S4: No), the process returns to step S1. In contrast, when the user inputs an operation to the touch sensor 6 (step S4: Yes), e.g. a tap or a flick by a thumb, it is determined whether the operation is inside the operation area A. When the operation is not inside the operation area A (step S5: No), the operation is invalidated in step S6, and the process returns to step S1.

In contrast, when it is determined that the operation is inside the operation area A (step S5: Yes), the operation is validated in step S7. Then, the operation information representing the user's operation is transmitted to the HMI control ECU 10 through the vehicle IF 8, in step S8. Subsequently, the process from step S2 is repeated. As a result, the user can input operations to start and end the hands-free call, for example, by tapping or flicking with the thumb while holding the grip portion 3 of the steering wheel 2.

In the above-described configurations, the operation area setting unit 13 of the control unit 7 is configured to set the operation area A at a position where the user's finger surely reach the operation area A without awkward actions and without being conscious about the operation invalid area such that the user can input operations easily. Accordingly, the operations by the user's finger in the operation area A of the touch sensor 6 can be surely detected by the operation detector 14 of the control unit 7.

According to the vehicle input device 1 of the present embodiment, the following effects can be obtained in the device including the touch sensor 6 provided in the steering wheel 2. The vehicle input device 1 can be easy to use for various users having a different size of the hand, a different position to hold the steering wheel, a different manner of holding the steering wheel, and a different position of the finger. Further, erroneous operations can be suppressed. In the present embodiment, the holding position determiner 12 is configured to appropriately set the operation area A based on the size of the user's hand and the position of the finger. Further, the size of the user's hand and the position of the finger can be surely determined using the pattern matching based on the machine learning.

In the above-described embodiment, an example where the hands-free call using the mobile phone (car phone) that is an in-vehicle device is operated by the vehicle input device 1 is described. However, the vehicle input device can be used for different usages. Further, the operation area A can be set at a position where the user can operate the touch sensor 6 with the index finger. Various modifications can be made to the hardware configuration of the vehicle input device 1. For example, the touch sensor may be a resistive film touch sensor.

Although the present disclosure has been described in accordance with the embodiments, it is understood that the present disclosure is not limited to the embodiments and structures disclosed therein. The present disclosure also includes various modifications and variations within an equivalent range. In addition, various combinations and forms, and further, other combinations and forms including only one element, or more or less than these elements are also within the scope and the scope of the present disclosure.

What is claimed is:

1. A vehicle input device comprising:
a touch sensor provided in a grip portion of a steering wheel;
a holding position determiner configured to, based on an input signal from the touch sensor,
determine whether a user is holding the grip portion, and
determine a holding position at which the user is holding the grip portion;
an operation area setting unit configured to, based on the holding position, set an operation area of the touch sensor at a position adjacent to a thumb and an index finger of a user's hand; and
an operation detector configured to detect an operation by a finger of the user to the operation area of the touch sensor, wherein
the holding position determiner is configured to determine a size of the user's hand and a position of the finger,
the operation area setting unit is configured to set the operation area of the touch sensor based on the size of the user's hand such that the operation area is large when the user's hand is large, and
the operation area setting unit is configured to set the operation area of the touch sensor based on the position of the finger such that the operation area is adjacent to the finger and thereby the finger reaches the operation area.

2. The vehicle input device according to claim 1, wherein
the holding position determiner is configured to determine the size of the user's hand and the position of the finger using a pattern matching based on a machine learning.

3. A vehicle input device comprising:
a touch sensor provided in a grip portion of a steering wheel; and
a processor coupled with the touch sensor, wherein
the processor is programmed to:
determine whether a user is holding the grip portion based on an input signal from the touch sensor;
determine a holding position at which the user is holding the grip portion based on the input signal from the touch sensor;
determine a size of a user's hand;
determine a position of a thumb of the user's hand based on the holding position;
set an operation area of the touch sensor at a position adjacent to the thumb based on the position of the thumb such that the thumb reaches the operation area, and based on the size of the user's hand such that the operation area is larger when the user's hand is larger; and
detect an operation by the thumb to the operation area of the touch sensor.
